(19) United States
(12) Patent Application Publication
(10) Pub. No.: US 2012/0208390 A1
(43) Pub. Date: Aug. 16, 2012

(54) CONNECTOR ASSEMBLY AND A CONNECTOR PART THEREOF

(75) Inventor: Marcus Davies, Mountain Ash (GB)

(73) Assignee: AB CONNECTORS LIMITED, Mountain Ash, Rhondda Cynon Taff (GB)

(21) Appl. No.: 13/504,470

(22) PCT Filed: Nov. 5, 2010
(86) PCT No.: PCT/GB10/02047

§ 371 Date: Apr. 26, 2012

(30) Foreign Application Priority Data
Nov. 5, 2009 (GB) 0919442.4

(51) Int. Cl. H01R 13/627

(52) U.S. Cl. 439/350

(57) ABSTRACT

There is a discussed a connector assembly having a plug member, a sleeve member slidably mounted around the plug member, and a receptacle member. One end of the sleeve member is connectable and disconnectable to the receptacle member by virtue of either a first flexing movement or a second flexing movement in dependence upon the position of the sleeve member relative to the receptacle member, hi this way, different decoupling forces are required to separate the connector assembly in dependence on the relative position of the sleeve member and the plug member.

This invention relates to a novel connector assembly and a novel connector forming part of the connector assembly. The invention has particular, but not exclusive, relevance to a connector assembly for providing an optical or electrical connection.

A connector assembly preferably provides a secure connection when connected, but also allows easy release. U.S. Pat. No. 3,160,457 discusses a connector assembly having a quick-disconnect mechanism. In particular, the connector assembly of U.S. Pat. No. 3,160,457 has a generally cylindrical plug member, a receptacle member and a coupling sleeve which is mounted around the plug member. In use, the coupling sleeve and the plug member are inserted into the receptacle member. The end of the coupling sleeve which engages the receptacle member has a series of circumferentially-spaced longitudinal slots formed therein, thereby forming a series of longitudinal “fingers” around the circumference of the coupling sleeve. The ends of these fingers are flared.

When the coupling sleeve is inserted into the receptacle member, the finger ends are flexed inwardly by a bevelled surface at the entry of the receptacle member allowing the sleeve member and plug member to be inserted until the finger ends reach a recess and spring back into the recess. By capturing the flared finger ends in this recess, a secure connection is achieved. To disconnect the coupling assembly, a user grips the coupling sleeve and pulls which causes the flared finger ends to engage an inner ramp surface of the recess such that the finger ends flex inwardly, allowing the coupling sleeve and plug member to be easily withdrawn from the receptacle member, thereby providing the quick-disconnect mechanism.

The connector assembly of U.S. Pat. No. 3,160,457 is arranged such that pulling on the plug member itself causes a surface on the plug member to capture the finger ends against a surface of the recess in the receptacle member, thereby preventing accidental disconnection.

Typically, at least one of the plug member and receptacle member of U.S. Pat. No. 3,160,457 would be connected to a cable. A problem with such an arrangement is that if a hard force is applied to the cable then, because the connector assembly prevents disconnection, damage may be caused to the cable or a device on which one part of the connector assembly is mounted, or an injury may be caused to a person. For example, a hard force may be applied when an operator either unintentionally catches the cable or deliberately tugs the cable in an attempt to disconnect the connector assembly quickly.

The present invention provides a connector assembly having a plug member, a receptacle member and a sleeve member mounted around the plug member, in which the connector assembly has two release mechanisms. The first release mechanism allowing release on application of a first decoupling force on the sleeve member and the second release mechanism allowing release on application of a second decoupling force on the plug member, the second decoupling force being larger than the first decoupling force.

Aspects of the invention are set out in the accompanying claims.

Exemplary embodiments of the invention will now be described with reference to the attached figures, in which:

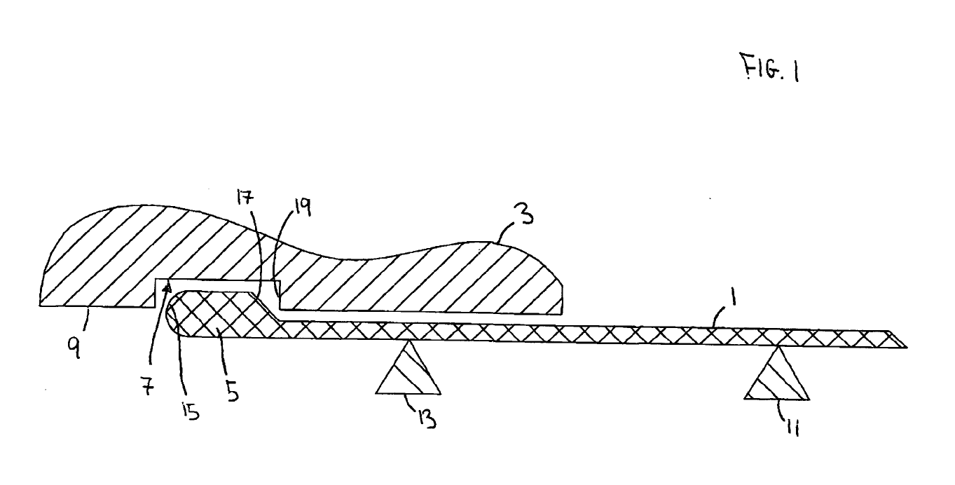

FIG. 1 schematically shows release mechanisms of a connector assembly according to the invention;

FIG. 2 schematically shows in more detail the release mechanisms of FIG. 1;

FIG. 3 schematically illustrates operation of a first release mechanism of FIG. 2;

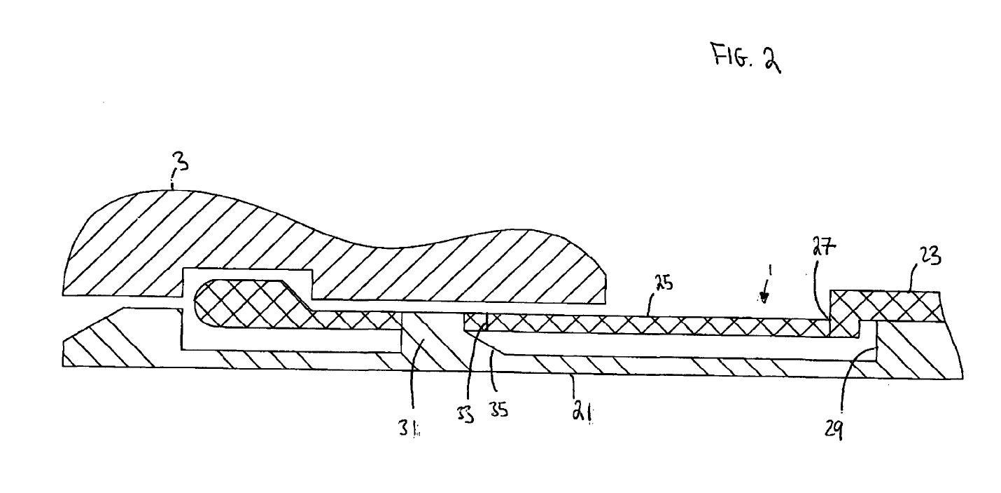

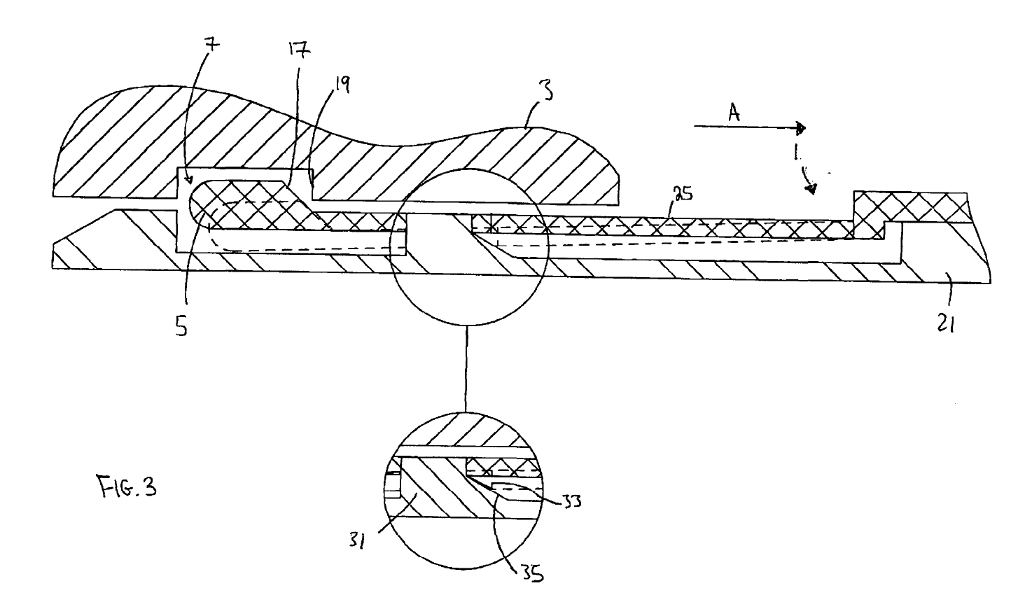

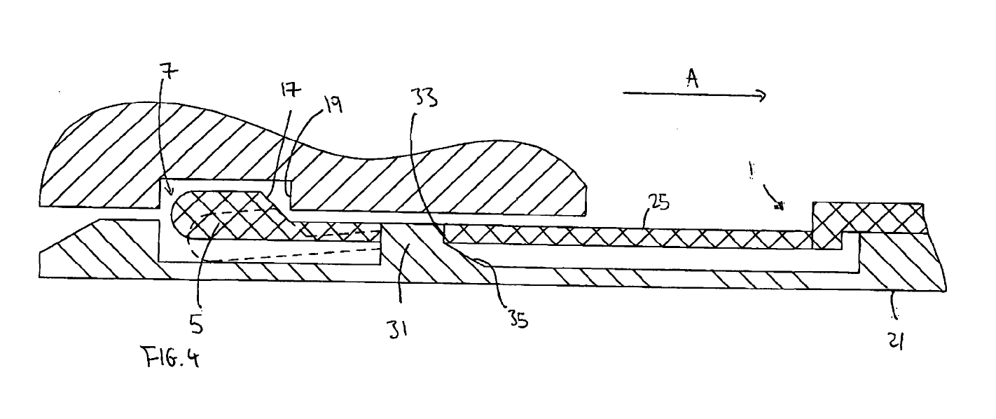

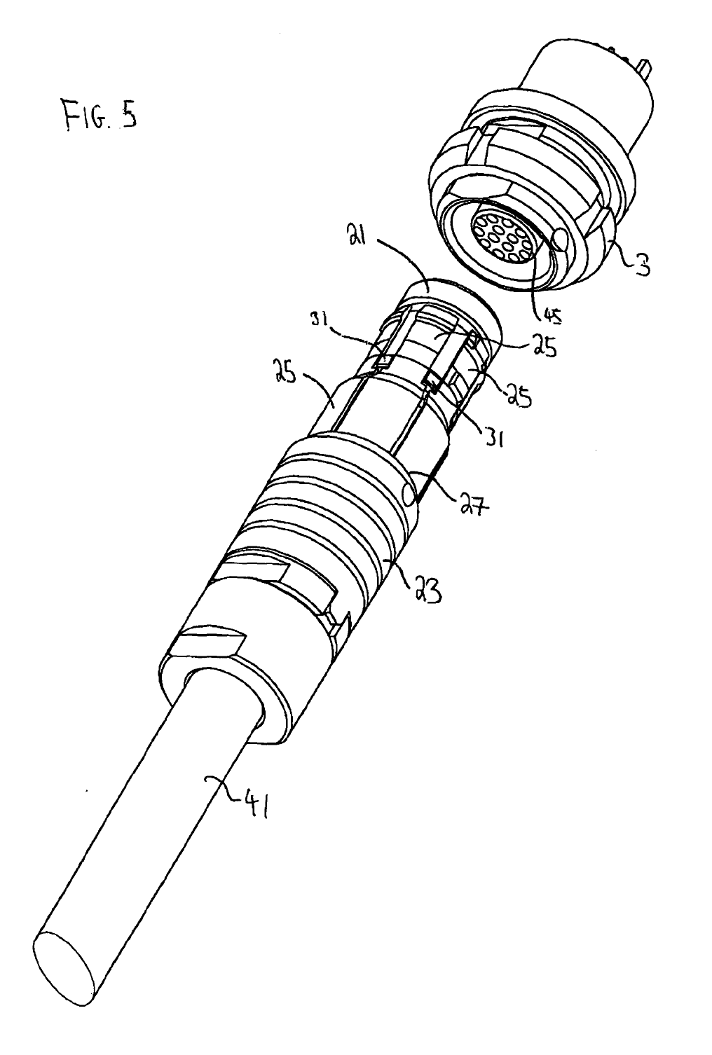

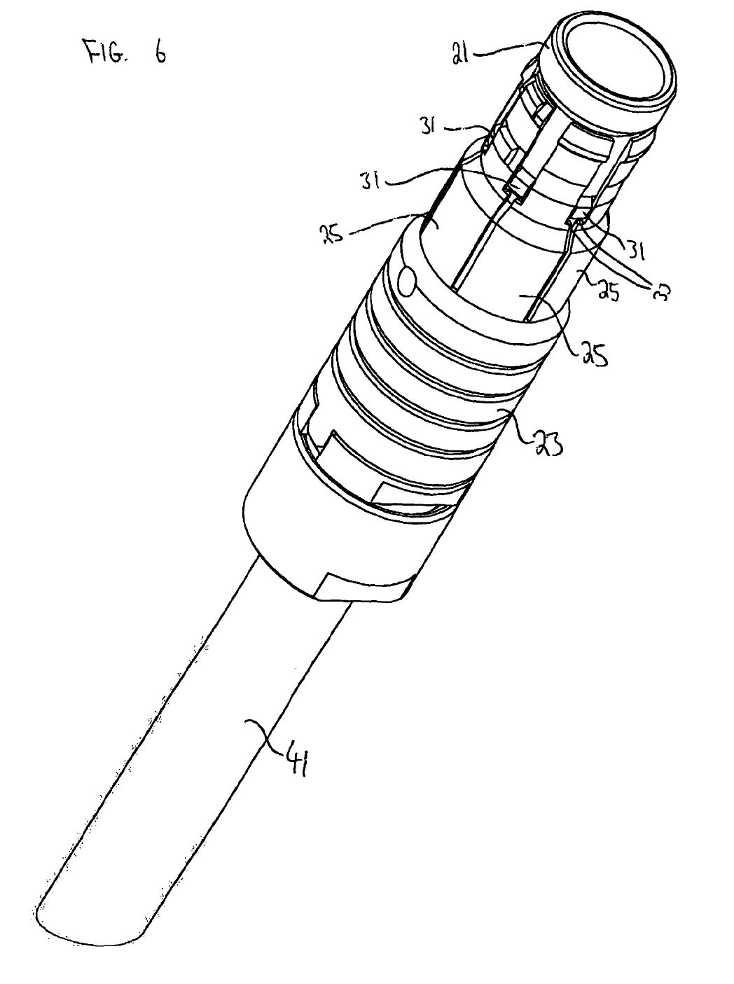

FIG. 4 schematically illustrates operation of a second release mechanism of FIG. 2;

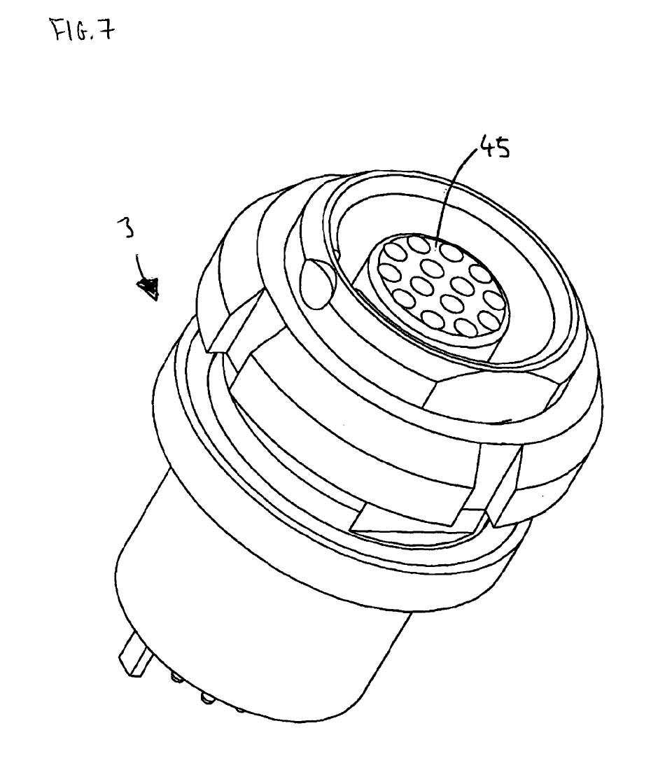

FIG. 5 is a perspective view of a connector assembly according to the invention in a disconnected state;

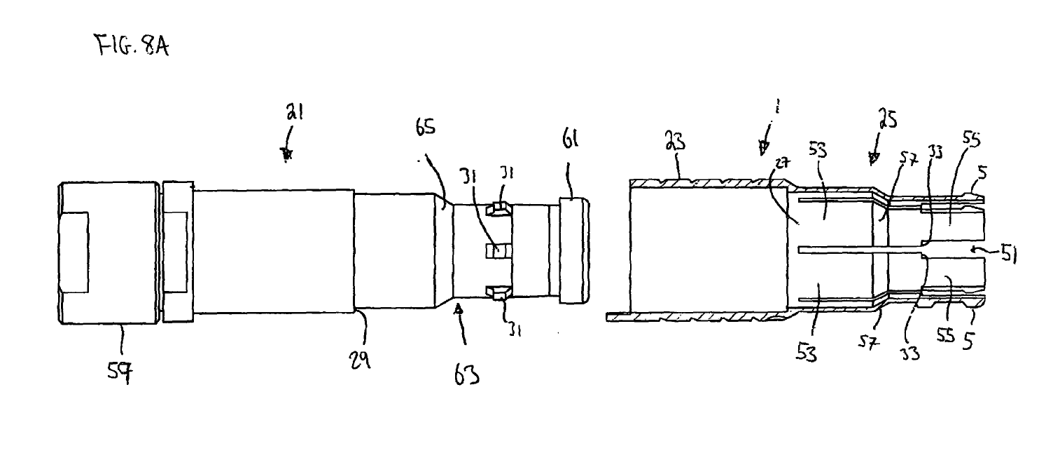

FIG. 6 is a perspective view of a plug member, with a sleeve member mounted thereon, forming part of the connector assembly of FIG. 5;

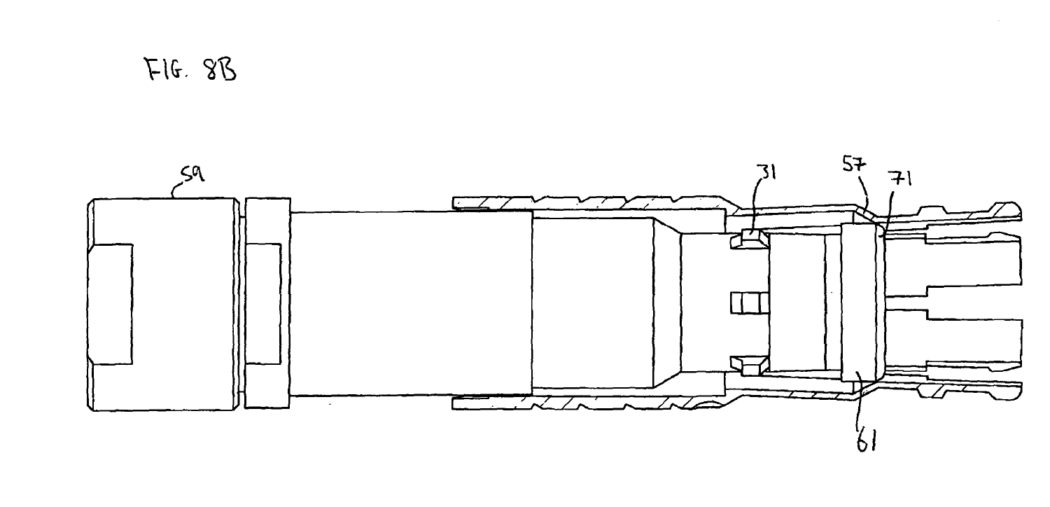

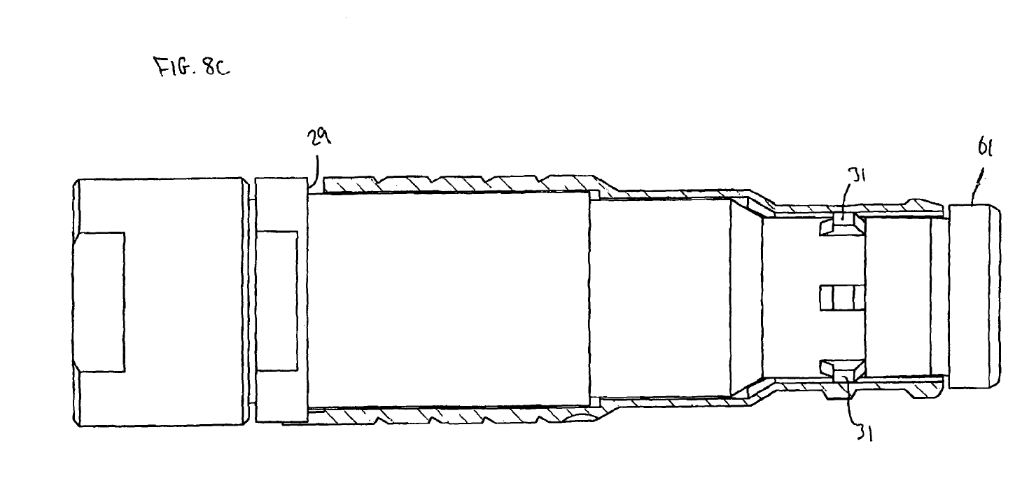

FIG. 7 is a perspective view of a receptacle member forming part of the connector assembly of FIG. 5;

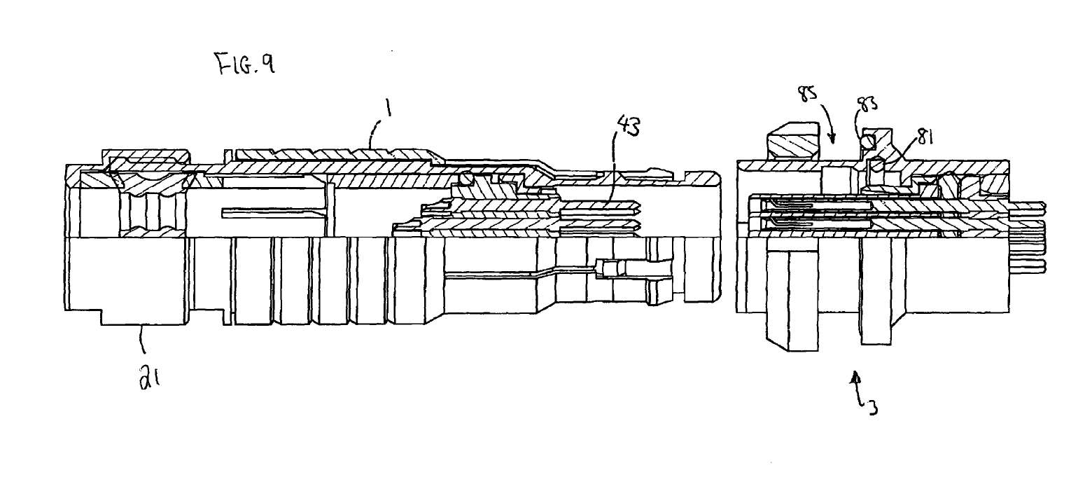

FIGS. 8A to 8C are side views showing the mounting of the sleeve member onto the plug member of FIG. 5, with the sleeve member shown in section;

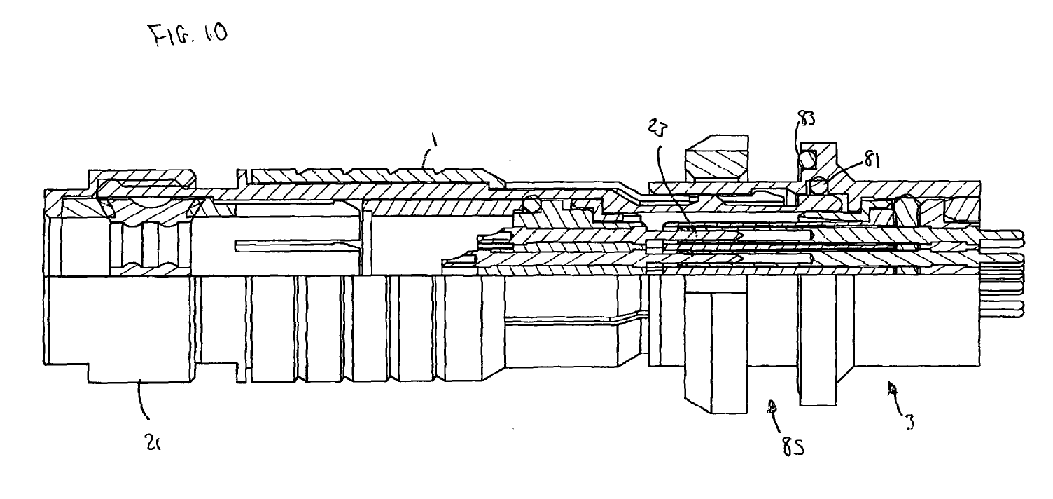

FIG. 9 is a part-sectional view of the connector assembly of FIG. 5 in a disconnected state;

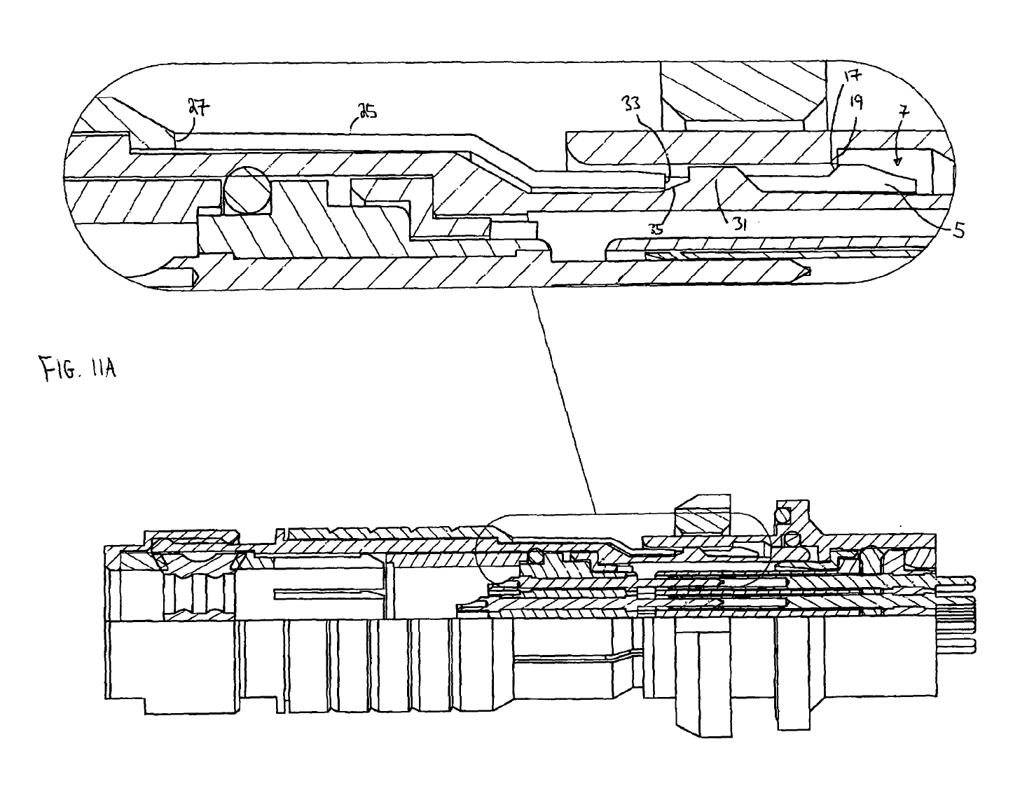

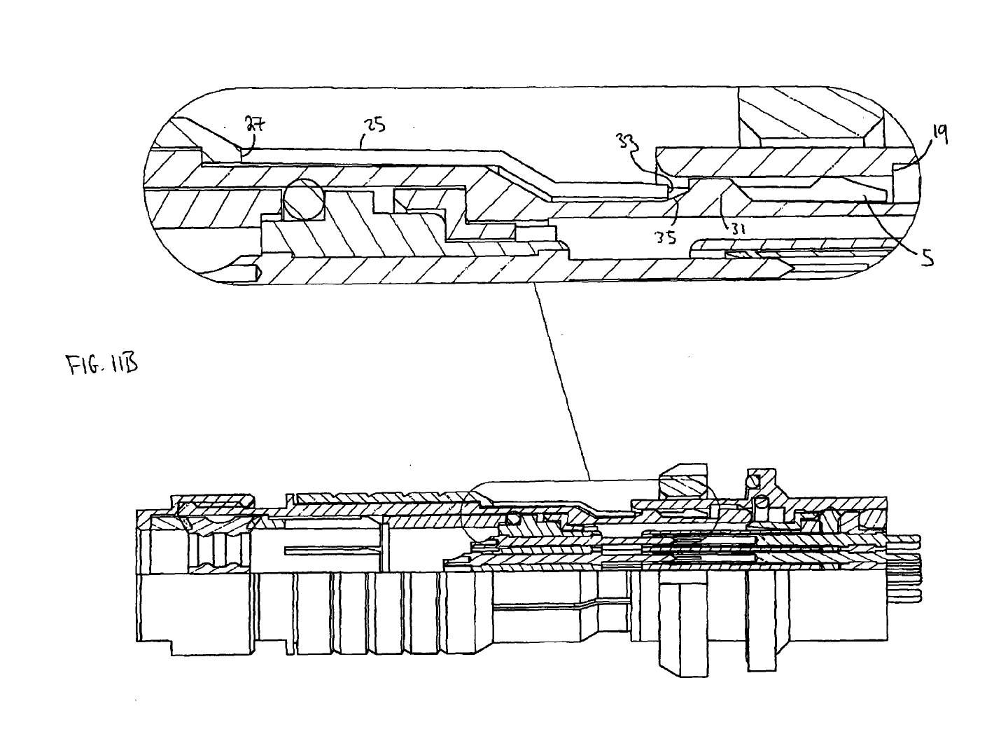

FIG. 10 is a part sectional view of the connector assembly of FIG. 5 in a connected state;

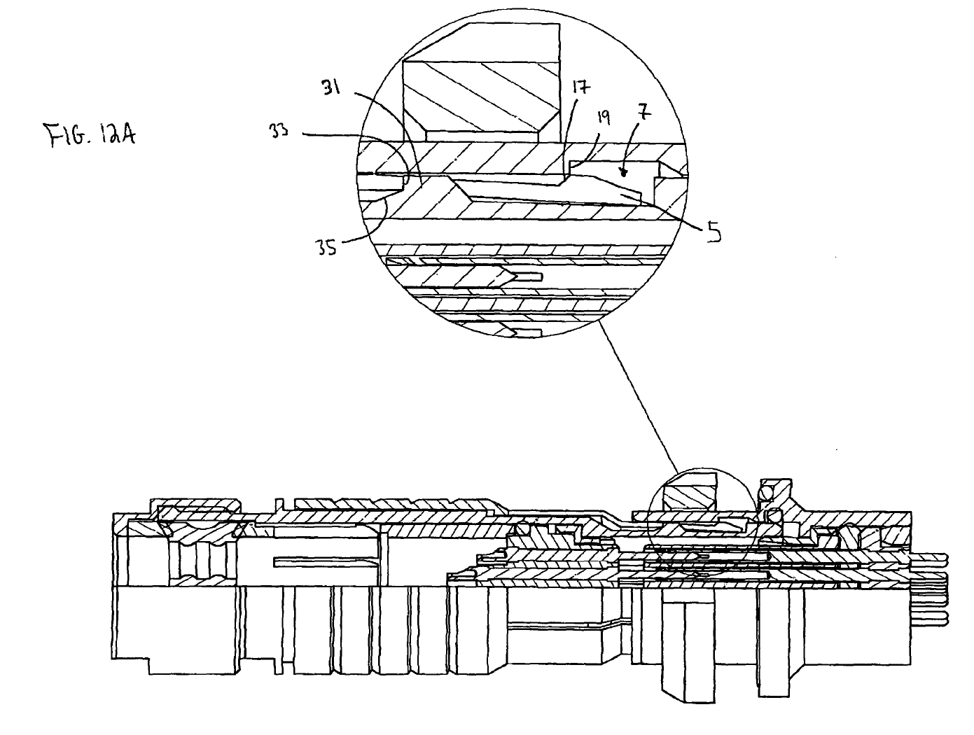

FIGS. 11A and 11B illustrate operation of the first release mechanism of the connector assembly of FIG. 5;

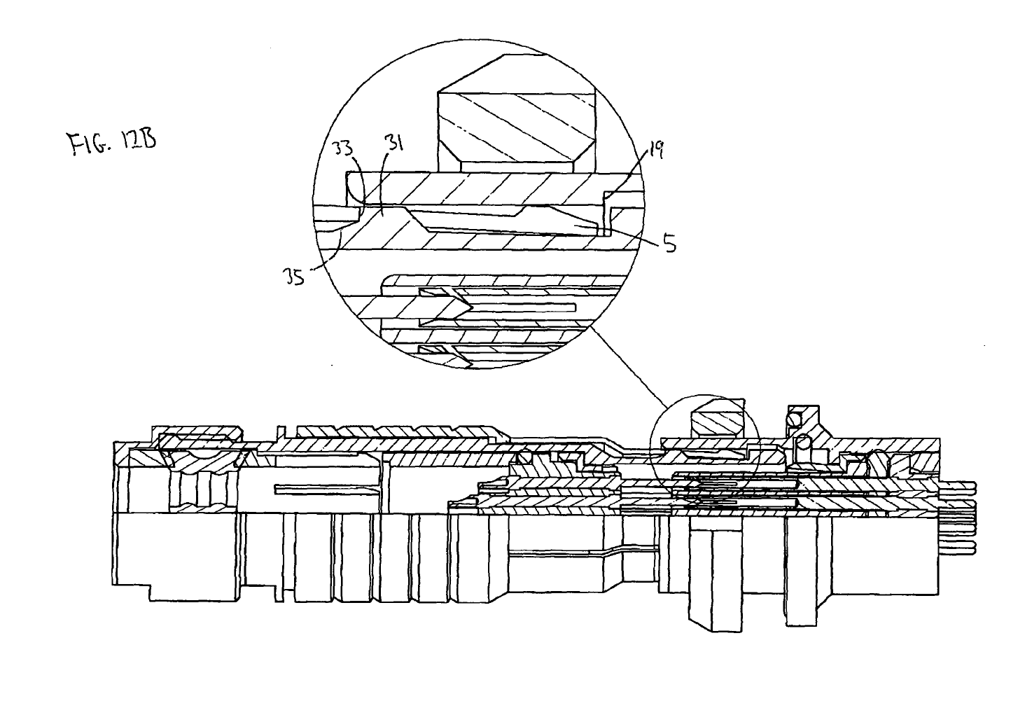

FIGS. 12A and 12 B illustrate operation of the second release mechanism of the connector assembly of FIG. 5; and

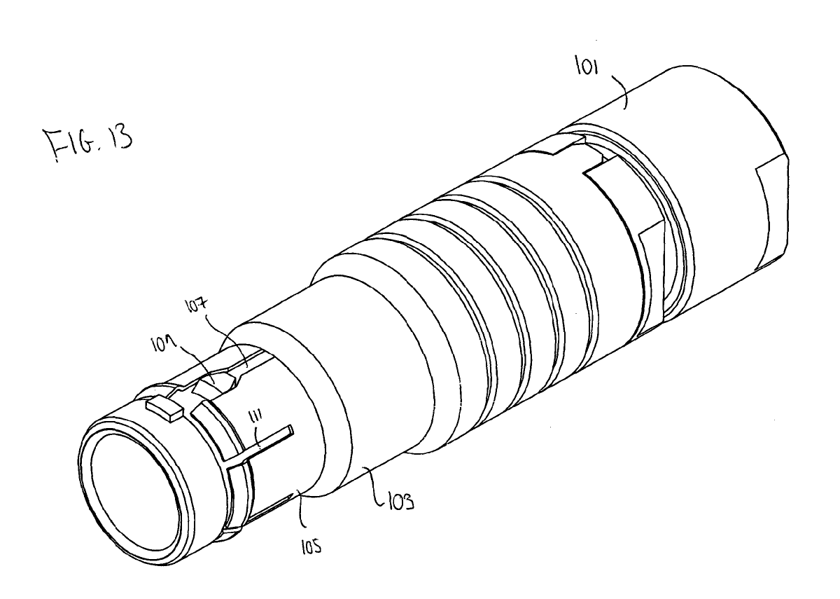

FIG. 13 is a perspective view of an alternative plug member, with an alternative sleeve member mounted thereon.

FIG. 1 schematically shows the operation of the release mechanisms of a connector assembly according to the present invention. In particular, FIG. 1 schematically shows a sectional view through a portion of a generally cylindrical sleeve member 1 and a generally cylindrical receptacle member 3. The sleeve member 1 has a flared end 5 which is located in a recess 7 formed in an inner surface 9 of the receptacle member 3. The sleeve member 1 is mounted around a plug member (not explicitly shown in FIG. 1) such that the sleeve member 1 can slide relative to the plug member over a limited range.

In accordance with the present invention, the sleeve member 1 is able to pivot about either a first pivot point 11 or a second pivot point 13 in dependence upon the relative position of the sleeve member 1 and the plug member. As the first pivot point 11 is further from the end 5 than the second pivot point 13, when the first pivot point 11 is operational a smaller force is required to move the end 5 of the sleeve member inwardly (i.e. away from the inner surface 9 of the receptacle member 3) than when the second pivot point 13 is operational.

In use, when the sleeve member is gripped by a user the first pivot point 11 is operational. Accordingly, when inserting the sleeve member 1 into the receptacle member 3, the user grips the sleeve member 1 and the sleeve member 1 deflects comparatively easily about the first pivot point 11 when a distal sloped portion 15 of the end 5 first engages the receptacle member 3 to allow the sleeve member 1 to be inserted to the point that the end 5 springs back into the recess 7 and the connector assembly is then in a connected state. Similarly, with the standard release mechanism the user grips the sleeve member 1 and applies a decoupling force, causing the sleeve member 1 to deflect about the first pivot point 11 when a proximal sloped surface 17 of the end 5 engages a side surface 19 of the recess 7, so that the end 5 moves out of the recess 7 and the sleeve member 1 (and the plug member) is removable from the receptacle member 3.

However, if when the connector assembly is in the connected state a user pulls the plug member away from the receptacle member 3, the resulting relative movement between the sleeve member 1 and the plug member causes the second pivot point 13 to become operational. With the second pivot point 13 operational, in comparison with the standard release mechanism a larger decoupling force is required for the end 5 to deflect inwardly when the proximal sloped surface 17 of the end 5 engages the side surface 19 of the recess 7 such that the end 5 moves out of the recess 7 and the sleeve member 1 is removable from the receptacle member 3. Hereinafter, disconnecting the connector assembly by applying a decoupling force directly on the plug member will be termed the emergency release mechanism, although it will be appreciated that it need not only be used in an emergency.

As discussed above, for the emergency release mechanism a larger decoupling force is required to disconnect the sleeve member 1 from the receptacle member 3 than for the standard release mechanism. Those skilled in the art will appreciate that the decoupling force required to disconnect the sleeve member 1 from the receptacle member 3 in the emergency release mechanism can be adjusted by adjusting the position of the second pivot point 13. In particular, moving the second pivot point 13 away from the end 5 of the sleeve member 1 will reduce the required decoupling force for the emergency release mechanism whereas moving the second pivot point 13 towards the end 5 of the sleeve member 1 will increase the required decoupling force for the emergency release mechanism.

FIG. 2 shows in more detail the release mechanism of the connector assembly, in particular showing features of the plug member 21 and more detail of the sleeve member 1. In this embodiment, the sleeve member 1 has a continuous cylindrical portion 23 at one longitudinal end and a plurality of equal-length “fingers” 25 at the other longitudinal end. The point 27 where the fingers 25 contact the continuous cylindrical member 23 is the first pivot point.

As shown in FIG. 2, the fingers 25 of the sleeve member 1 are generally located within a circumferential recess provided in the plug member 21. An end surface 29 of the circumferential recess limits sliding movement of the sleeve member 1 relative to the plug member 21 in one longitudinal direction (corresponding to the configuration shown in FIG. 2), while a series of circumferentially spaced lugs 31 project through gaps between the fingers 25 and limit sliding movement of the sleeve member 1 relative to the plug member 21 in the other longitudinal direction by engaging indent surfaces 33 on the fingers 25. When, the lugs 31 engage the indent surfaces 33 of the fingers 25, a ramp surface 35 on each lug 31 inhibits inward flexing of the fingers 25 and thereby forms the second pivot point.

FIG. 3 shows the flexing of the fingers 25 of the sleeve member 1 when a decoupling force is applied to the sleeve member 1 in the direction A. The decoupling force causes the proximal sloped surface 17 at the end 5 of each finger 25 to engage the side surface 19 of the recess 7, thereby generating a torque which causes the fingers 25 to flex inwardly about the first pivot point. The ramp 35 on the lug 31 and the proximal sloped surface 17 on the end 5 are designed so that as the fingers 25 flex inwardly and the sleeve member 1 slides out of the receptacle member 3, the indent surfaces 33 never engage the ramp 35 providing the decoupling force is applied to the sleeve member 1.

In contrast, as shown in FIG. 4 when a decoupling force is applied to the plug member 21 in the direction A, the plug member 21 slides relative to the sleeve member 1 in the direction A until the lugs 31 engage the indent surfaces 33, at which time the sleeve member 1 is moved in the direction A causing the proximal sloping surface 17 to engage the side surface 19 of the recess 7. When this occurs, the reaction force generates a torque about the second pivot point as the ramp 35 on the lug prevents flexing about the first pivot point. While inward flexing does occur about the second pivot point, the amount of decoupling force required to flex the ends 5 of the fingers 25 out of the recess 7 is greater than when pivoting occurs about the first pivot point.

Having described the operational principles of an embodiment of the invention, a connector assembly according to the invention will now be described with reference to FIGS. 5 to 12. In FIGS. 5 to 12, features corresponding to those in FIGS. 1 to 4 have been referenced by the same numeral.

FIG. 5 shows the connector assembly in a disconnected state, while FIG. 6 shows the plug member 21 together with the sleeve member 1 and FIG. 7 shows the receptacle member 3. As shown, a plug member 21 is connected to a cable 41. The cable 41 is connected to a plurality of male connectors 43 (shown in FIGS. 9 and 10 for example) which engage corresponding female connectors 45 in the receptacle member 3. In this embodiment, the cable 41 carries electrical signals. It will be appreciated that a decoupling force applied to the cable 41 will be transferred to the plug member 21.

As can be seen from FIGS. 5 to 7, in this embodiment the sleeve member 1, plug member 21 and receptacle member 3 all have generally circular cross-sections.

FIG. 8A shows the plug member 21 and the sleeve member 1 in a separated state, with the sleeve member shown in section. As shown, the sleeve member 1 has the continuous cylindrical portion 23 at one end and the fingers 25 at the other end. The fingers 25 are separated by slots 51 which are narrow adjacent to the continuous cylindrical portion 23 but widen in a stepwise manner at a longitudinal point away from the continuous cylindrical portion 23. In this way, each finger 25 has a wide finger portion 53 adjacent the continuous cylindrical portion 23 and a narrow finger portion 55 adjacent the end of the sleeve member 1. The circumferential surfaces at the points where the width of the slots vary correspond to the indent surfaces 33 referred to previously.

As shown in FIG. 8A, adjacent to the continuous cylindrical portion 23, the radius of the fingers 25 matches that of the continuous cylindrical portion 23. At a position between the continuous cylindrical portion 23 and the indent surfaces 33, the fingers have an inwardly sloping portion 57 during which the radius decreases over an interval, and then the radius of the fingered portion remains substantially constant to the end of the sleeve member 1.

The plug member 21 has a cable end portion 59 for connecting to the cable 41 at one end, and a flange portion 61 having a continuous cylindrical surface at the other end. The continuous cylindrical surface of the flange portion 61 facilitates the forming of a seal using an O-ring in the receptacle member 3 as will be described hereafter. Adjacent the flange portion 61 is the recessed portion 63 in which the circumferentially-spaced lugs 31 are formed. The recessed portion 63 includes a sloping portion 65 which generally matches the sloping portion 57 of the sleeve 1. At the cable end of the recess portion 63, the radius of the plug member 21 increases in a step-like manner to form the previously referred to end surface 29.

In this embodiment, the plug member 21 is integrally formed. The radius of the flange portion 61 of the plug member 21 is greater that the radius of the portion of the sleeve member 1 corresponding to the ends of the fingers 25. As shown in FIG. 8B, as the plug member 21 in inserted into the sleeve member 1, a bevel surface 71 on the flange portion 61 of the plug member 21 engages the inside of the sloping portion 57 of the fingers 25 causing the finger 25 to splay outward from the base 27 of the fingers 25 (i.e. the first pivot point) until, as shown in FIG. 8C, the flange portion 61 has passed completely through the sleeve member 1 and the fingers 25 spring back to their original configuration (as shown in FIG. 8A) with the lugs 31 protruding between the narrow finger portions 55.

As shown best in FIG. 8C, when the sleeve member 1 is mounted around the plug member 21, sliding movement of the sleeve member 1 relative to the plug member 21 is inhibited in one direction by the sleeve member 1 abutting the end surface 29, while as best shown in FIG. 6 sliding movement of the sleeve member 1 relative to the plug member 21 is inhibited in the other direction by the indent surfaces 33 of the sleeve member 1 abutting the lugs 31. However, some sliding movement of the sleeve member 1 relative to the plug member 21 is permitted.

FIGS. 9 and 10 respectively show the connector assembly in disconnected and connected states, with part of the assembly sectioned. As shown, an O-ring 81 is provided within the receptacle member 3 which, when the connector assembly is in the connected state as shown in FIG. 10, abuts the continuous circumferential surface of the flange portion 61 of the plug member 21, thereby providing a seal for the electrical connection.

As also shown in FIGS. 9 and 10, the receptacle member 3 includes a mounting portion allowing the receptacle member 3 to be mounted through a hole in a panel, for example through the wall of an instrument. An O-ring 83 is provided in the receptacle member 3 for abutting such a panel in order to provide a seal.

FIGS. 11A and 11B show the plug member 21 being disconnected from the receptacle member 3 by the application of a decoupling force to the sleeve member 1, i.e. using the standard release mechanism. As shown, the lug 35 does not abut the indent surface 33, and therefore when the proximal sloped surface 17 of the end 5 of the sleeve member 1 engages the end surface 19 of the recess 7, the fingers 25 flex about the base 27 of the fingers 25 (i.e. the first pivot point) until the end 5 exits the recess 7 (see FIG. 11B).

In contrast, in the emergency release mechanism a decoupling force is applied to the plug member 21, for example by pulling the cable 41, causing the lugs 31 to engage the indent surfaces 33 (see FIG. 12A) so that when the proximal sloped surface 17 of the end 5 of the sleeve member 1 engages the end surface 19 of the recess 7, the fingers 25 flex about the top of the ramp 35 (i.e. the second pivot point) until the end 5 exits the recess 7 (see FIG. 12B). As a result of moving the pivot point closer to the end 5 of the sleeve member 1, a greater decoupling force is required to disconnect the connector assembly when using the emergency release mechanism than when using the standard release mechanism.

### MODIFICATIONS AND FURTHER EMBODIMENTS

In the main embodiment discussed above, the end 5 flexes about a first pivot point in the standard release mechanism, in the emergency release mechanism the flexing about the first pivot point is inhibited and the end 5 flexes about a second pivot point. It is not, however, essential that the flexing movements are about respective pivot point. All that is required is that the standard release mechanism utilises a first flexing movement while the emergency release mechanism inhibits the first flexing movement and utilises a second flexing movement. To illustrate this, an alternative plug member and sleeve member assembly will now be described with reference to FIG. 13.

As shown in FIG. 13, a plug member 101 has a sleeve member 103 mounted thereon. The sleeve member 103 includes an end portion 105 having a surface with an axial gap 107 such that the circumference of the end portion 105 is not continuous. The axial gap 105 has a wider portion adjacent the end surface of the sleeve member 103, the wider portion being connected to a narrower portion via a chamfered portion. A lug 109 provided on the plug member 101 is positioned in the axial gap 105. The end portion 105 also includes plural axial slots 111 which extend from the end of the sleeve member 103 to a position about two-thirds of the way along the end portion 105.

The sleeve member 103 can be moved relative to the plug member 101 between a first position, in which the lug 109 is away from the chamfered portion, and a second position, in which the lug 109 abuts the chamfered portion. In the standard release mechanism, the sleeve member 103 is in the first position, and a user can squeeze the end portion 105 resulting in a first flexing movement which reduces the cross-section of the end of the sleeve member 103, thereby disengaging the end of the sleeve member 103 from the receptacle member. In the emergency release mechanism, a pulling motion on the plug member 101 moves the sleeve member 103 to the second position relative to the plug member 101. In the second position, the lug 109 inhibits the first flexing movement, but a second flexing movement can occur about the base of the fingers formed by the axial slots 111.

An advantage of the arrangement shown in FIG. 13 is that the end portion 105 can be manufactured by patterning sheet metal and then bending the patterned sheet metal into shape.

Although the indent surfaces in the main embodiment are perpendicular to the direction of sliding movement, this is not essential. Indent surfaces at other angles could also be used, and these may engage similarly angled surfaces on circumferentially-spaced lugs.

In the main embodiment, sliding movement of the sleeve member relative to the plug member causes a lug on the plug member to engage indent surfaces on the sleeve member, the indent surfaces being located at a point where the width of fingers on the sleeve member change width in a stepwise manner. In this way, the pivot point about which the fingers flex is shifted. Other configurations are possible to cause a shift in the pivot point in response to sliding movement of the sleeve member relative to the plug member. For example, in an alternative embodiment of the invention the sleeve member has fingers of constant width, with an inward projection located somewhere along the length of the fingers. This inward projection is received in a groove in a plug member which has a closed end which limits the sliding movement of the sleeve member relative to the plug member. When the projection is away from the closed end of the groove, the fingers are free to flex about their bases. However, when the projection engages the free end of the groove, a ramp surface at the closed end limits flexing movement of the fingers, thereby generating a second pivot point.

While the sliding movement in the main embodiment is axial (i.e. along the axis of the cylindrical components), helical slots between the fingers could be used such that the sliding movement is helical.

Although in the main embodiment the sleeve member, plug member and receptacle member all have generally cylindrical cross-sections, this is not essential. For example, in an alternative embodiment the sleeve member, plug member and receptacle member could have oval cross-sections.

It will be appreciated that the connector assembly has two parts which may be sold separately. In particular, the composite sleeve member and plug member may be sold separately from the receptacle member. In an embodiment, the receptacle member forms part of a electrical apparatus whereas the composite sleeve member and plug member forms part of cable for connecting to the electrical apparatus.

As discussed with reference to FIGS. 8A to 8C, when the plug member is inserted through the sleeve member, the finger portions flex outwardly to allow the flange portion 61 to pass through the sleeve member. This advantageously allows the flange portion to be an integral part of the plug member. Accordingly, such a way of mounting the sleeve member on the plug member is considered to be inventive independent of the dual release mechanism using different pivot points.

Although the plug member of the main embodiment has male connectors and the receptacle member has female connectors, this is not essential as the plug member may have female connectors and the receptacle member may have male connectors or both the plug member and the receptacle member may have complementary mixtures of male members and female members.

1. A connector for a connector assembly, the connector comprising:
plug means; and
sleeve means slidably mounted on the plug means, the sleeve means having one end connectable to receptacle means,
wherein in a first position of the sleeve means relative to the plug means, a first flexing movement of said one end is operable to disconnect said one end from the receptacle means, and
wherein in a second position of the sleeve means relative to the plug means, said first flexing movement is inhibited and a second flexing movement of said one end is operable to disconnect said one end from the receptacle means.

2. A connector according to claim 1, wherein said first flexing movement is about a first pivot point and said second flexing movement is about a second pivot point.

3. A connector according to claim 2, wherein said one end of the sleeve means comprises a plurality circumferentially-spaced finger portions separated by slots such that the first pivot point is formed at the base of the finger portions.

4. A connector according to claim 3, wherein each of said finger portions has a width which varies at an intermediate point of the finger portion, thereby forming indent surfaces.

5. A connector according to claim 4, wherein the plug means comprises a plurality of circumferentially-spaced lugs, each lug being positioned in a respective slot to allow sliding movement of the sleeve means relative to the plug means, and
wherein the lugs are configured such that sliding movement of the sleeve means relative to the plug means is inhibited by the lugs engaging the indent surfaces.

6. A connector according to claim 5, wherein the lugs comprise ramp surfaces arranged such that the lugs form the second pivot point when the lugs engage the indent surfaces.

7. A connector according to claim 1, wherein said first flexing movement is operable to reduce the size of the cross-section of said one end, and wherein said second flexing movement is about a pivot point.

8. A connector according to claim 7, wherein at least the part of said sleeve means adjacent said one end has an axial gap to allow said first flexing movement.

9. A connector according to claim 8, wherein in said second position of the sleeve means relative to said plug means, a projection provided on said plug means inhibits said first flexing movement.

10. A connector according to claim 1, wherein the plug means comprises a flange portion for insertion in said receptacle means, the flange portion providing a continuous surface for proving a sealing contact with an O-ring in the receptacle means.

11. A connector according to claim 10, wherein said flange portion is an integral part of the plug means.

12. A connector according to claim 10, wherein the flange portion has a radial extent which is greater than a radial extent of the sleeve means.

13. A connector assembly according to claim 1 and further comprising receptacle means for connectably receiving said connector.

14. A connector assembly according to claim 13, wherein the sleeve means is connectable and disconnectable to the receptacle means by virtue of the flexibility of said one end.

15. A connector for a connector assembly, the connector comprising:
plug means; and
sleeve means slidably mounted on the plug means,
wherein one end of the sleeve means is connectable to receptacle means, said one end being flexible about either a first pivot point or a second pivot point in dependence on the position of the sleeve means relative to the plug means.
